(19) United States
(12) Patent Application Publication
(10) Pub. No.: US 2008/0159507 A1
(43) Pub. Date: Jul. 3, 2008

(54) DISTRIBUTED TELECONFERENCE MULTICHANNEL ARCHITECTURE, SYSTEM, METHOD, AND COMPUTER PROGRAM PRODUCT

(75) Inventors: Jussi Virolainen, Espoo (FI); Laura Laaksonen, Espoo (FI); Ali Ahmaniemi, Tampere (FI); Paivi Valve, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/616,638

(22) Filed: Dec. 27, 2006

(51) Int. Cl. H04M 3/42

(52) U.S. Cl. 379/202.01

(57) ABSTRACT

Provided are multichannel architectures, systems, methods, and computer program products for distributed teleconferencing using one or more master devices and/or a centralized conferencing switch. Multichannels enhance functionality of a master device in distributed teleconferencing and allow for compatibility with 3D capable teleconferencing. Multichannel distributed teleconferencing involves multichannel, monophonic, and/or a fixed number of uplink and downlink channels. A multichannel distributed teleconferencing system may perform active talker detection of near-end participants and communicate an ID signal on an uplink channel identifying the active near-end participants. A multichannel distributed teleconferencing system may also receive an ID signal on a downlink channel identifying the active far-end participants. A multichannel distributed teleconferencing system may perform various uplink and downlink processing. Uplink processing may involve multimixing and spatialization. Multimixing may be used to separate speech signals of near-end participants. Spatialization, also used in downlink processing, introduces spatial separation of active participants.

### FIELD OF THE INVENTION

Embodiments of the present invention relate generally to teleconferencing systems and, more particularly, to a multichannel architecture for distributed teleconferencing using one or more master devices and/or a centralized conferencing switch, and related systems, methods, and computer program products.

### BACKGROUND

A conference call is a telephone call in which at least three parties participate. Teleconference systems are widely used to connect participants together for a conference call, independent of the physical locations of the participants. Teleconference calls are typically arranged in a centralized manner, but may also be arranged in alternate manners, such as in a distributed teleconference architecture as described further below.

Reference is now drawn to FIG. 1, which illustrates a schematic block diagram of a plurality of participants effectuating a centralized teleconference session via a conferencing switch. The illustration is representative of a traditional centralized teleconferencing system connecting participants 102, 104, 106 at several Sites A, B, and C to a conference call, meaning that several locations are connected with one to n conference participants. The terminal or device at each site connects to the conference switch 100 as a stand-alone conference participant for the call. The conference switch 100, also referred to as a conference bridge, mixes incoming speech signals from each site and sends the mixed signal back to each site. The speech signal coming from the current site is usually removed from the mixed signal that is sent back to this same site.

Another type of centralized teleconferencing system is a centralized 3D teleconferencing system. A typical centralized 3D teleconferencing system is shown in FIG. 2. A centralized 3D teleconferencing system allows the use of spatial audio that provides noticeable advantages over monophonic teleconferencing systems. In a centralized 3D teleconferencing system, the speakers of participant terminals 112, 114, 116, 118 are presented as virtual sound sources that can be spatialized at different locations around the listener. 3D spatialization is typically achieved using head related transfer function (HRTF) filtering and including artificial room effect, although other examples of 3D processing include Wave field synthesis, Ambisonics, VBAP (Vector Base Amplitude Panning), SIRR (Spatial Impulse Response Rendering), DirAC (Directional Audio Coding), and BCC (Binaural Cue Coding). In a typical centralized 3D teleconferencing system, as shown in FIG. 2, monophonic speech signals from all participating terminals 112, 114, 116, 118 are processed in a conference bridge 110. For example, the processing may involve automatic gain control, active stream detection, mixing, and spatialization. The conference bridge 110 then transmits the 3D processed signals back to the terminals 112, 114, 116, 118. The stereo signals can be transmitted as two separately coded mono signals as shown with the user terminal 112 or as one stereo coded signal as shown with the user terminal 118.

Additional alternative implementations of 3D teleconferencing include concentrator and decentralized architectures. FIG. 3 illustrates a typical concentrator centralized 3D teleconferencing system. In a concentrator 3D teleconferencing architecture, terminals 122, 124, 126 send speech signals to a conference bridge 100 that forwards the signals to all the terminals 122, 124, 126 that participate in the conference call. In this type of a concentrator centralized 3D teleconferencing architecture, each participant provides a monophonic uplink to the conference bridge and receives a plurality of downlink channels from the conference bridge, each downlink channel representing one of the monophonic uplinks. FIG. 4 illustrates a typical decentralized 3D teleconferencing system. In a decentralized architecture, each terminal 132, 134, 136 has point-to-point connections to all the other terminals 132, 134, 136 in the conference call, without a need for a conference switch. In this type of decentralized teleconferencing architecture, each participant typically provides a multicast monophonic uplink and receives a plurality of downlink channels from the other participants. In both cases, 3D processing takes place in the terminals themselves. A disadvantage of both of these architectures for concentrator 3D teleconferencing and decentralized 3D teleconferencing is higher bandwidth consumption.

Another type of teleconference architecture is a distributed arrangement that involves a master device providing a connection interface to the conference call for one or more slave terminals. And in a distributed teleconferencing architecture, one or more conference participants may be in a common acoustic space, such as one or more slave terminals connected to the conference call by a master device. This type of distributed arrangement is described further in relation to FIG. 5, which illustrates a schematic block diagram of a plurality of participants in a distributed teleconference session, where the conference is effectuated via a conferencing switch 148 and several participants from a common acoustic space participate in the conference via slave terminals 142, 144, 146 through a master device 140. FIG. 6 illustrates a more detailed functional block diagram related to a master device in a distributed teleconferencing system. The concept of distributed teleconferencing, as the term is defined and used in the present application, refers to a teleconference architecture where at least some of the conference participants are co-located and participate in the conference session using individual slave terminals, such as using their own mobile devices and/or hands free headsets as their personal microphones and loudspeakers, connected through a master device, such as a mobile terminal of one of the conference participants acting as both a terminal for that conference participant and as the master device, or another computer device providing communication to all of the slave terminals, such as a personal or laptop computer or a dedicated conferencing device. In such instances, a common acoustic space network, such as a proximity network, can be established in accordance with any of a number of different communication techniques such as RF, BT, Wibree, IrDA, and/or any of a number of different wireless and/or wireline networking techniques such as LAN, WLAN, WiMAX and/or UWB techniques. For example, a WLAN ad hoc proximity network may be formed between the mobile devices 140, 142, 144, 146 in a room while one of the devices 140 acts as a master device. Communication may take place, for example, using a WLAN ad hoc profile or using a separate access point. The master device 140 connects to a conference switch 148 (or to another master device or, for example, directly to a remote participant device 149 at a second location 147), and the master device 140 receives microphone signals from all the other (slave) terminals 142, 144, 146 in the room 141, and also the microphone signal from the master device 140 if also acting as a participant terminal for the conference call. To facilitate effectuation of a conference session for the participants in the proximity network, the master device 140 is capable of operating a mixer 150 with corresponding uplink encoders 152 and decoders 154, 156, 158 and corresponding downlink encoders 162 and decoders 160. The mixer may comprise software operable by a respective network entity (e.g., master device 140), or may alternatively comprise firmware and/or hardware. Also, although the mixer is typically co-located at the master device of a common acoustic space network, the mixer can alternatively be remote from the master device, such as within a conferencing switch. The master device 140 runs a mixing algorithm for the mixer that generates a combined uplink signal from all of the individual slave terminal microphone signals. Depending upon the mixing algorithm used by the master device, the uplink signal may be an enhanced uplink signal. At the downlink direction, the master device receives speech signals from the teleconference connection and shares this signal with the other (slave) terminals, such as to be reproduced by the hands free loudspeakers of the all terminals in the room. Using this type of distributed teleconferencing, speech quality at the far-end side is improved, for example, because microphones are proximate the participants. At the near-end side, less listening effort is required from the listener when multiple loudspeakers are used to reproduce the speech.

During a distributed conferencing session, the participants of the conference session, including those within respective common acoustic space network(s), can exchange voice communication in a number of different manners. For example, at least some, if not all, of the participants of a common acoustic space network can exchange voice communication with the other participants independent of the respective common acoustic space network but via one of the participants (e.g., the master device) or via another entity in communication with the participants, as such may be the case when the device of one of the participants or another device within the common acoustic space network is capable of functioning as a speakerphone. Also, for example, at least some, if not all, of the participants of a common acoustic space network can exchange voice communication with other participants via the common acoustic space network and one of the participants (e.g., the master device) or another entity within the common acoustic space network and in communication with the participants, such as in the same manner as the participants exchange data communication. In another example, at least some of the participants within a common acoustic space network can exchange voice communication with the other participants independent of the common acoustic space network and any of the participants (e.g., the master device) or another entity in communication with the participants. It should be understood, then, that although the participants may be shown and described with respect to the exchange of data during a conference session, those participants typically may also exchange voice communication in any of a number of different manners.

A distributed teleconferencing architecture is further described in International Patent Application Number PCT/FI2005/050264 entitled “System for Conference Call and Corresponding Devices, Method and Program Products,” the contents of which are incorporated herein by reference in their entirety with regard to further disclosing distributed teleconferencing architectures, systems, devices, methods, and computer program products.

Traditional and recently developed teleconferencing solutions, including centralized 3D teleconferencing and distributed teleconferencing, are currently not compatible with each other from an audio processing viewpoint. For example, in centralized 3D teleconferencing, a user terminal should be able to receive either stereo or multichannel signals from the conference network, while distributed teleconferencing is based on monophonic connections. When some participants in a conference call participate using distributed teleconferencing and other participants participate using centralized 3D teleconferencing, the result is suboptimal. The participants with 3D-capable terminals are not able to spatially separate voices of those participants that are coming from a distributed teleconferencing system due to the monophonic uplink connection of distributed systems. The performance of a distributed system is limited, for example, because spatial separation during simultaneous speech is not possible due to the monophonic downlink connection.

Although techniques have been developed for effectuating conference sessions in distributed arrangements and centralized arrangements and for effectuating conference systems that are capable of representing 3D effects for the conference, it is desirable to improve upon these existing techniques. For example, there is a need in the art for improved architectures, systems, methods, and computer program products for providing compatibility between distributed teleconferencing and 3D capable teleconferencing systems.

### SUMMARY

In light of the foregoing background, embodiments of the present invention provide multichannel architectures, systems, methods, and computer program products for distributed teleconferencing using one or more master devices and/or a centralized conferencing switch. The present invention provides a multichannel audio architecture that enhances the functionality of a master device in a distributed teleconferencing system, such as a proximity or other network of a common acoustic space. Embodiments of the preset invention allow for compatibility between distributed teleconferencing and 3D capable teleconferencing systems, such as centralized 3D teleconferencing systems. Thus, 3D capable terminals and terminals that are part of a distributed teleconferencing system can participate in the same teleconference session with 3D audio features enabled for all participants, including those participating with the distributed teleconferencing system.

Embodiments of distributed teleconferencing systems of the present invention are provided that include multichannel conference communications. An embodiment may include multichannel uplink and monophonic downlink. Another embodiment may include multichannel uplink and multichannel downlink. Other embodiments may include a fixed number of uplink channels, such as a two-channel uplink and either multichannel or monophonic downlink. Other embodiments may include multichannel uplink and a fixed number of downlink channels, such as a two-channel downlink. Alternate embodiments may include either multichannel uplink or a fixed number of uplink channels, such as a two-channel uplink, and any of a monophonic downlink, a multichannel downlink, or a fixed number of downlink channels.

In an embodiment with a fixed number of uplink channels, a system may also perform ID detection (active talker detection (ATD)) of the active participants and communicate an ID signal identifying the uplink signals for any number of the active participants. In an embodiment with a fixed number of downlink channels, a conferencing device may receive an ID signal identifying the downlink signals with the active participants represented in the downlink signals.

Embodiments of distributed telecommunications systems of the present invention are provided that perform at least one of uplink processing and downlink processing. Uplink processing may involve monomixing, summing, signal selection, multimixing, multiplexing, spatialization, automatic volume control (AVC), simultaneous talk detection (STD), double talk detection (DTD), voice activity detection (VAD), and other uplink signal processing. Downlink processing may involve spatialization and other downlink signal processing. Embodiments performing multimixing for uplink processing are advantageous for distributed teleconferencing systems with both monophonic and multichannel uplinks.

Multimixing may be used, such as to separate speech signals of simultaneously talking near-end participants. Resulting signals may be transmitted to the uplink direction over a multichannel connection. Uplink multimixing improves speech intelligibility for far-end listeners with 3D capability during simultaneous near-end speech. Uplink multimixing also improves listening intelligibility of simultaneous speech in a monophonic distributed teleconferencing system. An optional active talker indication (talker ID) signal may be sent with the uplink signal, or similarly with a downlink signal. And downlink mixing may be applied on multichannel signals received from the conference network, such as to introduce spatial separation during simultaneous talking of far-end participants. As a result, 3D-capable terminals that participate in a conference call may spatialize speech signals from a distributed teleconferencing system. Downlink mixing improves speech intelligibility for participants in the near-end environment during simultaneous far-end speech by participants with 3D teleconferencing capability and allow for the use of 3D terminals in a distributed network.

Embodiments of distributed telecommunications systems of the present invention are provided where a conferencing device, such as a master device, receives signals from a plurality of slave terminals in a common acoustic space, thereby effectuating a common acoustic network, and has a multichannel conferencing connection to any of (i) one or more other master device, (ii) one or more conference switches, (iii) one or more terminals in one or more acoustic spaces, or (iv) a combination of any number of any of the aforementioned conferencing devices.

Embodiments of distributed telecommunications system of the present invention are also provided where a conferencing device, such as a conference switch, supports connections from a plurality of participants, including receiving (i) monophonic or multichannel signals from one or more master devices of common acoustic space networks, (ii) monophonic or multichannel signals from a plurality of one or more terminals in one or more acoustic spaces, and/or (iii) a combination of any number of any of the aforementioned signals. If a conference switch receives a plurality of signals from terminals in a common acoustic space, the conference switch may perform multimixing on these uplink signals.

These characteristics, as well as additional details, of the present invention are described below. Similarly, corresponding and additional embodiments of multichannel architectures and related systems, methods, and computer program products of the present invention for distributed teleconferencing are also described below.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a schematic block diagram of a plurality of participants effectuating a centralized teleconference session via a conferencing switch;

FIG. 2 is a functional block diagram of a centralized 3D conferencing system;

FIG. 3 is a functional block diagram of a concentrator centralized 3D conferencing system;

FIG. 4 is a functional block diagram of a decentralized 3D conferencing system;

FIG. 5 is a schematic block diagram of a plurality of participants effectuating a distributed teleconference session, where the conference is effectuated via a conferencing switch and several participants are connected through a master terminal;

FIG. 6 is a functional block diagram of a master device of the distributed teleconferencing system of FIG. 5;

FIG. 7 is a functional block diagram of a master device of a distributed teleconferencing system of an embodiment of the present invention using multimixing and automatic volume control to enhance a monophonic uplink channel;

FIG. 8 is a functional block diagram of a mixer according to an embodiment of the present invention capable of multimixing a plurality of signals;

FIG. 9 is a functional block diagram of a master device of a distributed teleconferencing system of an embodiment of the present invention using a multichannel uplink connection;

FIG. 10 is a functional block diagram of a master device of a distributed teleconferencing system of an embodiment of the present invention using a two-channel uplink connection with active talk detection and active talk ID signaling;

FIG. 11 is a functional block diagram of a master device of a distributed teleconferencing system of an embodiment of the present invention that spatializes uplink channels;

FIG. 12 is a functional block diagram of a conference switch compatible with a multichannel distributed teleconferencing system of an embodiment of the present invention that spatializes received channels from participants;

FIG. 13 is a functional block diagram of a conference switch compatible with a multichannel distributed teleconferencing system of an embodiment of the present invention that spatializes received channels from participants and controls spatialization of channels from a multichannel distributed teleconferencing system with active talker ID signaling;

FIG. 14 is a functional block diagram of a conference switch compatible with a multichannel distributed teleconferencing system of an embodiment of the present invention that concentrates multiple input signals, including multichannel signals from a master device;

FIG. 15 is a functional block diagram of a master device of a distributed teleconferencing system of an embodiment of the present invention with a two-channel downlink connection;

FIG. 16 is a functional block diagram of a master device of a distributed teleconferencing system of an embodiment of the present invention with a multichannel downlink connection representing logical channels from far-end participants;

FIG. 17 is a functional block diagram of a conference switch of an embodiment of the present invention that is compatible with various types of teleconferencing systems;

FIG. 18 is a block diagram of a network framework that would benefit from embodiments of the present invention;

FIG. 19 is a schematic block diagram of an entity capable of operating as a terminal, computing system, and/or conferencing server in accordance with an embodiment of the present invention; and

FIG. 20 is a schematic block diagram of a mobile station capable of operating as a terminal, computing system, and/or conferencing server in accordance with an embodiment of the present invention.

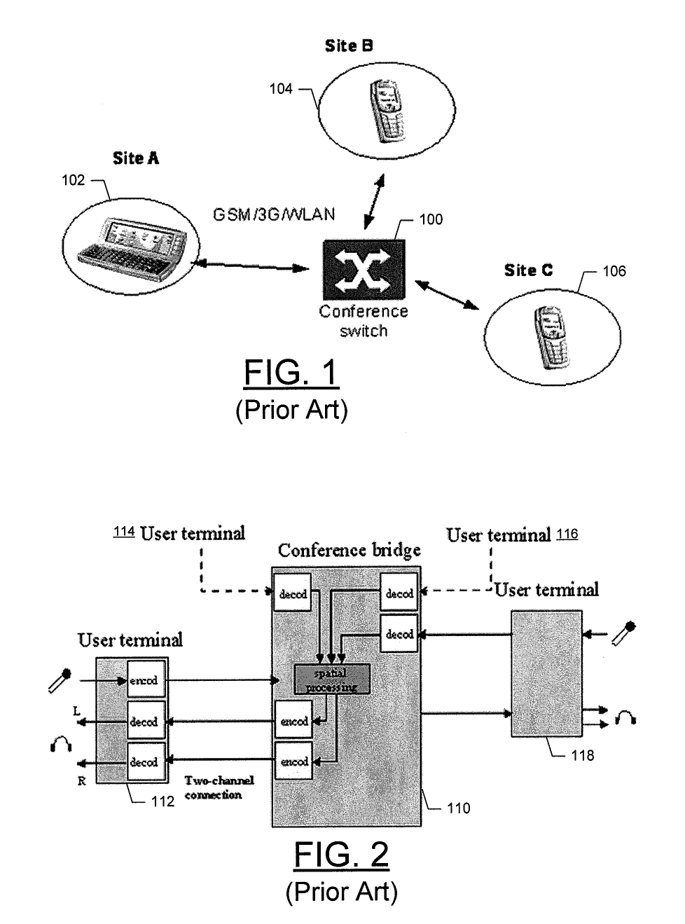

### DETAILED DESCRIPTION

Embodiments of the present invention will now be described more fully hereinafter with reference to the accompanying drawings, in which some, but not all embodiments of the invention are shown. Indeed, embodiments of the present invention may be embodied in many different forms and should not be construed as limited to the embodiments set forth herein; rather, these embodiments are provided so that this disclosure will satisfy applicable legal requirements. Like reference numbers refer to like elements throughout.

It will be appreciated from the following that many types of devices, such as devices referenced herein as mobile stations, including, for example, mobile phones, pagers, handheld data terminals and personal data assistants (PDAs), gaming systems, and other electronics, including, for example, personal computers, laptop computers, teleconferencing phones, teleconference servers, teleconferencing software systems, and other consumer electronic and computer products, may be used with the present invention. Further, while the present invention is described below with reference to WLAN and Bluetooth (BT) wireless access and communication protocols for establishing a proximity network in a common acoustic space, the present invention is applicable to wired and other wireless access and communication protocols for establishing a common acoustic space network, including, for example, WiMAX and UWB wireless protocols. Further, a conferencing device, such a slave terminal, of an embodiment of the present invention may include speech enhancement functionality, and including hardware and/or software, for example, for acoustic echo cancellation, noise suppression, and corresponding signal processing.

Further, while distributed teleconferencing at a common physical location has been referred to as being enabled by a proximity network, embodiments of the present invention may function with any type of distributed teleconferencing network supporting multiple terminals and/or multiple participants located in a common acoustic space, including, for example, a proximity network or a 3G circuit-switched connection network, collectively referred to herein as common acoustic space networks. The physicality of the multiple terminals and/or multiple participants being co-located in a common acoustic space provides the ability for a master device to effectuate distributed teleconferencing by receiving from and sending signals to multiple terminals in the common acoustic space, thereby effectuating a common acoustic space network.

Further, in addition to traditional telephone conference calls involving only audio signals, conference calls may also involve video signals. For simplicity, the preset application only refers to conference calls in the context of teleconference calls involving audio signals, simply referred to as voice, voice signals, speech, or speech signals. However, embodiments of the present invention may be used in videoconference applications where video signals are also included in the data transfer of the conference communications. Similarly, embodiments of the present invention may be used in a conference application where data is also included in the transfer of the conference communications. Further, audio, video, and/or data communications (or signals carrying or otherwise representing the audio, video, and/or data communications) is provided, exchanged, or otherwise transferred from one or more participants to one or more other participants, often through a conference switch. It should be understood, however, that the terms “providing,” “exchanging,” and “transferring” can be used herein interchangeably, and that providing, exchanging, or transferring audio, video, and/or data communications can include, for example, moving or copying audio, video, and/or data communications, without departing from the spirit and scope of the present invention.

It will be appreciated that embodiments of the present invention may be particularly useful for voice-over-IP (VOIP) conference calls. However, embodiments of the present invention are not limited to VOIP conference call applications, but may be applied in any teleconference systems, including those with circuit-switched connections, and with teleconference communications networks supporting multichannel transmissions. Also, although separately coded discrete codec instances are shown on each individual channel of a multichannel signal in the figures of embodiments of the present invention, a multichannel codec likely may be used with embodiments of the present invention. Further, for stereo or multichannel signals, separate channels may be coded using mono codecs or, a true stereo or a multchannel codec may be used.

As used herein, the term “participant” generally refers interchangeably to a participant and the participant's associated conferencing device or one or more conferencing devices supporting the participant's participation in the conference call. For example, reference to a participant in a conference generally also refers to a conferencing device, such as a user terminal, associated with or enabling participation of the participant. References to near-end participants and far-end participants provide conceptual directions for transmissions related to local and remote participants in a conference call. As used herein, the term “multiplexing” refers to “selecting” K output signals from N input signals.

Embodiments of the present invention provide a new teleconferencing architecture based on the concept of a master device in a distributed teleconferencing system having a multichannel conferencing connection to the network connecting the distributed teleconferencing system to other participants, whether co-located with the distributed teleconferencing system but not participating in a common acoustic space network with the master device or located remotely from the distributed teleconferencing system. By having a multichannel conferencing connection, a master device is able to send and receive multiple signals for effectuating a conference call, such as to send multiple signals to and receive multiple signals from a conference switch, other master terminal(s), and/or other participants. An embodiment of the present invention may also send multichannel signals to local terminals, as well, referring to those terminals that are in a common acoustic space network.

Embodiments of the present invention also may include improvements for both uplink and downlink signal processing operations. For example, uplink processing operations may be performed for each microphone signal that a master terminal receives from slave devices and sends to the network over multichannel conference communications. Uplink processing operations are performed by the master device prior to sending the processed signal(s) to the conference switch or other remote participant(s). Similarly, downlink processing operations may be performed for each signal that the master terminal receives from the network and sends to be reproduced by the loudspeakers of the slave devices.

One aspect of uplink processing that is particularly relevant to a master device of a distributed teleconferencing system of a common acoustic space network, such as a proximity network or a 3G circuit-switched connection network, is the performance of multimixing the multiple signals received from the slave terminals of the common acoustic space network. Distributed teleconferencing typically relies upon monophonic mixing, or mixing the multiple signals of the common acoustic space network into a single monophonic uplink signal. The mixing algorithm(s) that combines the separate microphone signals of the slave terminals into a monophonic uplink signal is an important aspect of any teleconferencing system. For example, a mixing algorithm may play an important role in defining the quality of the sound transmitted to an available for broadcasting at remote locations, and the listening experience of the far-end participants. A mixing algorithm typically relates to combining the most relevant signal(s) and, thereby, creating an uplink signal that represents the acoustical environment of the near-end participants for corresponding replication for the far-end participants.

One example of a mixing algorithm is a summing algorithm, where the output is formed by summing all of the input microphone signals. A disadvantage of a summing algorithm is decreased signal-to-noise ratios and an increased reverberation effect because of slight delay differences between the input signals. Another example of a mixing algorithm is a selection algorithm that selects only the determined best signal at a given time (e.g., the only active signal, the loudest signal, the clearest signal such as with the highest signal to noise ratio (SNR), etc.). A disadvantage of a selection algorithm is that only one active speaker can be heard at a time, and, for example, the selection algorithm may be subject to failing to find the microphone signal closest to the speaker. As such, some of the benefits of using multiple microphones may be lost. Accordingly, a mixing algorithm may be an intelligent, composite mixing algorithm that combines the benefits of both a summing algorithm and a single selection algorithm. Such an intelligent, composite mixing algorithm may result in improved signal-to-noise ratio, and decreased reverberation effects caused by the delay in different source-to-microphone transmission times, while also providing improved intelligibility and permit simultaneous talk support.

By comparison to monophonic mixing that results in a single signal output from multiple signal inputs, multimixing provides an enhancement to a typical mixing algorithm by performing multiple parallel mixing operations simultaneously for multichannel distributed teleconferencing. Multimixing is particularly advantageous when two or more people are talking simultaneously in a common acoustic space. For example, one mixer may be configured to pick up the speech of a first talker, and another mixer may be configured to pick up the speech of a second talker. In principle, multimixing operations may be scaled such that multiple simultaneous mixing operations may be run in parallel, however, typically multimixing of two signals may be sufficient because it is relatively rare that there is simultaneous speech of more than two participants in a common acoustic space at the same time.

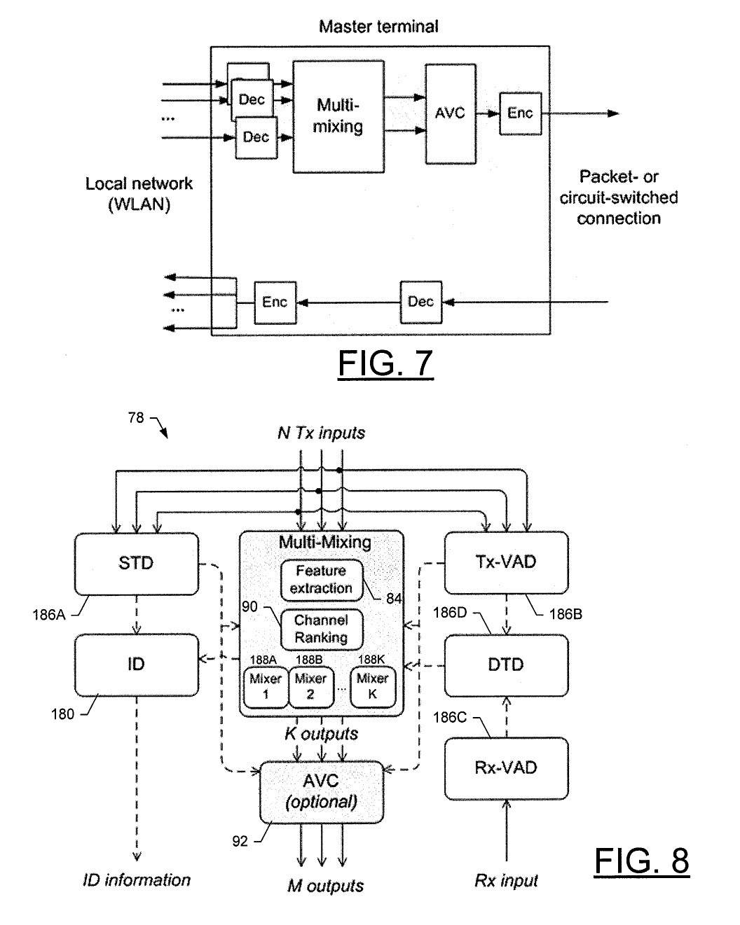

If a master device has only a monophonic connection to the conference network, multimixing may still be used to enhance the system, such as to balance the level of simultaneous speech signals using automatic volume control (AVC) functionality. For example, FIG. 7 is a functional block diagram of a master device of a distributed teleconferencing system of an embodiment of the present invention using multimixing and automatic volume control to enhance a monophonic uplink channel. Before a monophonic signal is sent in the uplink direction, a mixer or mixing software module may perform multimixing of multiple input signals with at least two resulting output signals. Automatic volume control (AVC) functionality may be performed upon the two resulting output signals from the multimixing to result in the single monophonic uplink signal. Multimixing a monophonic distributed teleconferencing system may be beneficial, for example, if one of two participants that are talking simultaneously has a much louder voice than the other talking participant or has a microphone that is much nearer to the first talking participant than the microphone is to the second talking participant. A far-end participant that listens to the balanced monophonic mix of simultaneous talking participants may more easily follow either or both of the two near-end talking participants. If the two near-end talking participants are perceived to talk equally loudly, regardless of any discrepancies in the original loudness of the participants' voices and/or the configuration of the microphones in relation to the talking participants. Accordingly, multimixing may also be beneficial to improve distributed teleconferencing systems where at least one conferencing device has only a monophonic uplink or a monophonic downlink conferencing connection.

When a master device is enabled for multichannel conferencing connections in the uplink direction, the multiple outputs from the multimixing may each be transmitted in their own uplink channel to the conferencing network. In an embodiment of the present invention that performs multimixing resulting in two output signals in the uplink direction, during simultaneous talking of two participants, a first output may include a majority of the speech of the first participant and a minority of the speech of the second participant and a second output may include a majority of the speech of the second participant and a minority of the speech of the first participant.

In a one-to-one multimixing implementation of an embodiment of the preset invention, each multimixed signal output may represent and correspond to the speech signal of a different participant of the conference call in the common acoustic space network. An alternate embodiment, for example, may involve N input signals from participants of a common acoustic space network and multimixing that results in K output signals fewer than N. Further, in an N:K implementation, automatic volume control functionality performed after the multimixing may further reduce the final output signals provided for the uplink direction, such as where K output signals result from the multimixing, and M output signals fewer than K result from the automatic volume control functionality. Such an embodiment may be referred to as an N:K:M implementation. A further alternate embodiment, for example, may involve N input signals from participants of a common acoustic space network and multimixing that results in N output signals, with subsequent automatic volume control functionality that reduces the multimixing output signals to M output signals provided for the uplink direction. Such an embodiment may be referred to as an N:N:M implementation.

FIG. 8 is a functional block diagram of a mixer, or software mixing module, 78 according to an embodiment of the present invention capable of and configured for multimixing a plurality of signals from participants within a common acoustic space network, thereby also referred to as a multimixer. The example implementation of multimixing shown in FIG. 8 includes N input signal channels to the multimixer and K output channels from the multimixer. Each of the input signals may be first processed at a feature extraction process 84 by a software feature extraction module. The extracted, and/or detected, features may then be used for ranking the channels at a channel ranking process 90 by a software channel ranking module, such as to rank the estimated probability of speech activity near a corresponding microphone. Then, K separate mixing operations, or separate software mixing subroutine modules, 188A, 188B, 188K may be run in parallel to result in K output signals, such as where each of the K output signals represents one active speaking participant. If the multimixing is based on a linear combination, the multimixing may be illustrated, for example, by the following equation:

$$[ \begin{matrix}{s}_{1} \\ ⋮ \\ {s}_{K}\end{matrix} ] = [ \begin{matrix}{a}_{11} & {a}_{12} & ⋯ & {a}_{1 N} \\ {a}_{21} & {a}_{22} & ⋯ & {a}_{2 N} \\ ⋮ & & & ⋮ \\ {a}_{11} & {a}_{11} & ⋯ & {a}_{KN}\end{matrix} ] [ \begin{matrix}{m}_{1} \\ {m}_{2} \\ ⋮ \\ {m}_{N}\end{matrix} ] \qquad Eq . 1$$

where S_{1 to K} are the output signals of the parallel K mixers, a_{11 to KN} are the mixing coefficients, and m_{1 to N} are the N input signals. It will be appreciated, however, that embodiments of the present invention may be implemented using many different mixing algorithms, including mixing algorithms used in and/or designed for monophonic distributed teleconferencing. Further, depending on the implementation, present use, and/or available transmission channels, the number of output signals from the multimixing may vary from one to N. In some example embodiments, the number of multimixed outputs may be fixed, and in other example embodiments, the number of multimixed outputs may increase or decrease in real-time, for example, with dependence upon factors such as the number of active talking participants in the common acoustic space network and the available bandwidth for the multichannel conferencing connection. When K is the number of output signals from the multimixing, if K is 1, then the multimixing corresponds to a monophonic mixing embodiment. If K is greater than or equal to two and less than or equal to N−1 (2≦K≦N−1), then the multimixer performs 2−(N−1) parallel mixing operations in which a first output signal represents the participant near the highest ranked slave terminal, a second output signal represents the participant near the second highest ranked slave terminal, etc. A typical implementation may include K output signals from the multimixer, where K is equal to 2, representing the common situation where no more than two speakers are simultaneously talking at the location of the common acoustic space network. If K is equal to N, such that the number of output signals equals the number of input signals, then the individual mixers of the multimixer calculate a linear combination of the multiple input signals so that each output signal represents the participant speaking near the corresponding microphone for the input signal. A simple mixing matrix corresponding to a K=N situation is a diagonal matrix that simply outputs the corresponding input signals.

As may be included in monophonic mixing operations, multimixing operations may also include different voice activity matrices for different situations. For such implementations, and otherwise to further enhance multimixing operations, additional functional processes and corresponding software modules may be included for simultaneous talk detection (STD) 186A, active talker identification detection (ID, Tx ID, or ATD) 180, voice activity detection (VAD) in the uplink direction (Tx-VAD) 186B of input signals from participants in the common acoustic space network and in the downlink direction (Rx-VAD) 186C of received signals from other participants in the conference not in the common acoustic space network, and double talk detection (DTD) 186D. Classes of voice activity for a mixing matrix may include, for example, at least the following cases:
no active talker (speech pause) when there is no actively speaking participant in the common acoustic space network;
uplink speech activity (Tx talk) when there is one actively speaking participant in the common acoustic space network;
simultaneous talk (ST) when there are multiple (at least two) actively speaking participants in the common acoustic space network;
downlink speech activity (Rx talk) when there is at least one actively speaking participant outside of the common acoustic space network;
double talk (DT) when there is one actively speaking participant in the common acoustic space network and at least one actively speaking participant outside of the common acoustic space network; and
simultaneous/double talk (SDT) when there are multiple (at least two) actively speaking participants in the common acoustic space network and at least one actively speaking participant outside of the common acoustic space network.

An embodiment of the present invention may also include an automatic volume control process, or software module, 92 for balancing the loudness levels (volumes) of the participants. As described above with regard to an N:K:M implementation of the present invention, the number of signals from the multimixing to an automatic volume control operation may be different from (less than) the number of output signals in the uplink direction. This is particularly true if the output in the uplink direction is a monophonic signal and multimixing is used for automatic volume control purposes during simultaneous talking situations of participants in a common acoustic space network.

Another embodiment of the present invention may use beamforming techniques for multimixing uplink processing, such as using time delay of arrival (TDOA) and linear combination. In addition, if it is desired to better separate speech signals from each other or to better separate speech signals from background noise, an embodiment of the present invention may use blind source separation techniques, such as ICA (independent component analysis), since all the voices of all simultaneous speakers in amplitude mixing leak to all the mixing outputs. Blind source separation technique may be used to adaptively find coefficients for a mixing matrix, such as Equation 1, for example.

The better the separation between the actively speaking participants in a common acoustic space, the smaller the correlation between the corresponding multimixer outputs. Accordingly, in a further embodiment of the present invention, correlation between multimixed output signals may be artificially reduced by decorrelation methods, such as using complementary comb-filtering or pitch shift after the multimixing and before transmitting the signals if the uplink direction. Such an embodiment may be beneficial in situations when two simultaneous talking participants in the common acoustic space network are both far from the available microphones. If the correlation is too high, it is possible that spatialization of these signals in the receiver may not work as expected when phantom image generation is strong. Decorrelation helps resolve this problem. The use of decorrelation may be controlled by estimating the correlation between the multimixer outputs, and if the multimixer outputs are correlating more than desired, decorrelation may be applied.

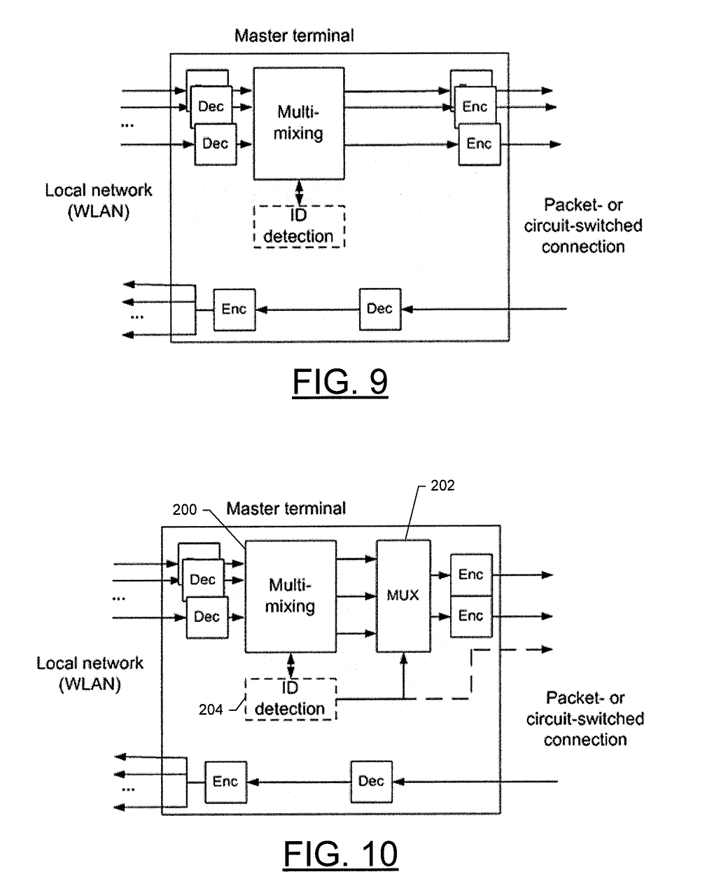

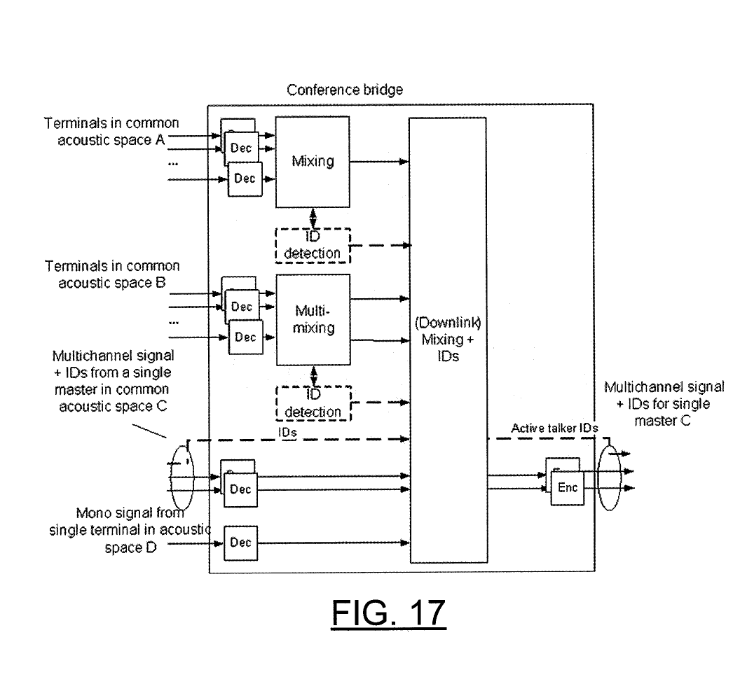

As already described above, multichannel distributed teleconferencing may be implemented in a number of ways, including, for example, various combinations of the different implementations shown and described herein, such as the conference switch of FIG. 17 that supports conferencing connections to multiple different types of conferencing devices for participants in different acoustic spaces. Certain implementations, however, dictate using additional features that support that particular implementation. For example, FIG. 9 is a functional block diagram of a master device of a distributed teleconferencing system of an embodiment of the present invention using a multichannel uplink connection. In FIG. 9, each uplink channel is logically connected to the conference switch from the master device. Accordingly, there needs to be as many uplink channels as there are slave terminals for near-end participants, or as many uplink channels as there are detected near-end participants. Thus, the identifier for a stream (or logical channel) is, at the same time, the identifier for the slave terminal (or talker ID), and ID detection is, by default, built into the multichannel multimixing, although a talker ID signal could also be transmitted in the uplink direction, such as depicted in FIG. 10. If separate real-time transport protocol (RTP) streams are used, the streams need to be synchronized by the receiver, such as a conferencing switch or master device. In practice, logical channels can be transmitted over a fewer number of physical channels, for example, over a maximum of three channels, and discontinuous transmission (DTX) functionality may be used to reduce bandwidth. A simple example of this type of implementation is to transmit all of the input microphone signals as one of the multichannel uplink streams. Where active talker identification detection is performed, a detection algorithm may take into account speech signal related features, such as estimated pitch, format frequencies, etc.

As above, certain implementations dictate using additional features that support that particular implementation. By way of another example, FIG. 10 is a functional block diagram of a master device of a distributed teleconferencing system of an embodiment of the present invention using a fixed two-channel uplink connection with active talk detection and active talk ID signaling. A limited, fixed number of logical uplink channels may be transmitted to the conference network. In FIG. 10, the master device is configured to provide a fixed two-channel uplink conferencing connection, and the number of logical and physical channels is the same, both two channels. Two active channels are selected in all of the multimixed output channels by the multimixer 200 and then multiplexed to the two uplink channels by a multiplexer 202. For such an implementation, the master device also provides an identifier associated with each channel to indicate the identification (or talker ID) of the active slave terminal (or participant). To provide an identifier, the master device performs active talker identification detection, such as by an active talker identification detection software module 204. The identifier for each channel changes when the active talking participant changes, and the master device continuously monitors the active talking participants to provide an identifier for each channel that corresponds to the active talking participants. When there are simultaneously talking participants, different identifiers may be used for the channels. In one example embodiment, a real-time protocol stream may be used that carries the multichannel signal. In another example embodiment, the two input microphone signals detected as having the highest energy (volume of the talking participant) may be transmitted on the two available uplink channels.

As described briefly above, embodiments of the present invention may also perform simultaneous talk detection (STD) as part of the multimixing operation, or in parallel with the multimixing operation. Simultaneous talk detection is used to detect how many near-end participants are actively talking and, thereby, possibly determine how many active signals are transmitted by the master device to the conferencing network. For example, in the embodiment of FIG. 10, when there is only one actively talking participant in the common acoustic space network, a first channel may carry the multimixing signal of the first (and only) talking participant, the talker ID of the first actively talking participant is associated with the first channel, and the second channel may be muted or used to carry the speech of another (silent) participant, such as a participant that may have been talking previously. When a second participant in the common acoustic space network begins to actively talk simultaneously with the first talking participant, the simultaneous talk detection can activate the multimixing operation to multimix the input microphone signal for this second actively talking participant. The multimixer may than transmit the multimixed signal for the second actively talking participant on the second channel, and the talker ID for the second actively talking participant may be associated with the second channel. Thus, when there is a maximum of two simultaneous actively talking participants, the input microphone signals for the two actively talking participants may be transmitted on respective uplink channels. If there are more actively talking participants then available uplink channels, some form of prioritization may be used to select which of the actively talking participants will be multiplexed to the available uplink channels.

Active talker identification (or active talker identification determination) may be advantageous for various purposes, including control for 3D spatialization and visualization of which participants are actively talking. Identity detection functionality (for active talker identification) may take different forms in various embodiments of the present invention. For example, depending on how identity detection functionality is implemented in a master device, the talker ID associated with an uplink channel may be an identification of the slave terminal from which the signal on the uplink channel is primarily composed, or the talker ID associated with an uplink channel may be an identification of an actively talking participant in the common acoustic space network. In this latter case, where the talker ID associated with the uplink channel is the identification of an actively talking participant in the common acoustic space network, identity detection functionality implemented in the master device may be capable of and configured for detecting the identity of more participants in the common acoustic space network than there are slave terminals in the common acoustic space network. For example, the talker ID may be associated with a SIP user URI that is specific for each participant, such as johnsmith@session123.telco.com. This type of identity detection functionality generally requires an identity detection algorithm to enable the master device to identify the participants in the common acoustic space network. Identity detection algorithms that may be used with embodiments of the present invention may be based upon, for example, binary vectors, scale or probability vectors, and/or real-time protocol specific signaling. An example of a binary vector identity detection algorithm is [1,0,1,0,0,0] where the common acoustic space network includes six participants, and participants one and three are actively talking during the current identity detection estimation. An example of a scale or probability vector identity detection algorithm is [0.5, 0.0, 0.7, 0.0, 0.0 0.0] where the common acoustic space network includes six participants, and the probability of participant one actively talking is 0.5 and the probability of participant three actively talking is 0.7. An example of a real-time protocol specific signaling identity detection algorithm involves (a) one real-time protocol stream carrying the multichannel signal with the first synchronization source (SSRC) identifier in the contributing source (CSRC) list describing which participant is actively talking as the main active source and (b) multiple real-time protocol streams used to carry the multichannel signals with the first synchronization source (SSRC) identifier in the contributing source (CSRC) list describing which participant is actively talking as the main active source, where the first synchronization source may be used to indicate that only one participant is actively talking if the first source is the same for all streams, and where different synchronization sources on at least two streams indicates that there are simultaneous actively talking participants in the common acoustic space network.

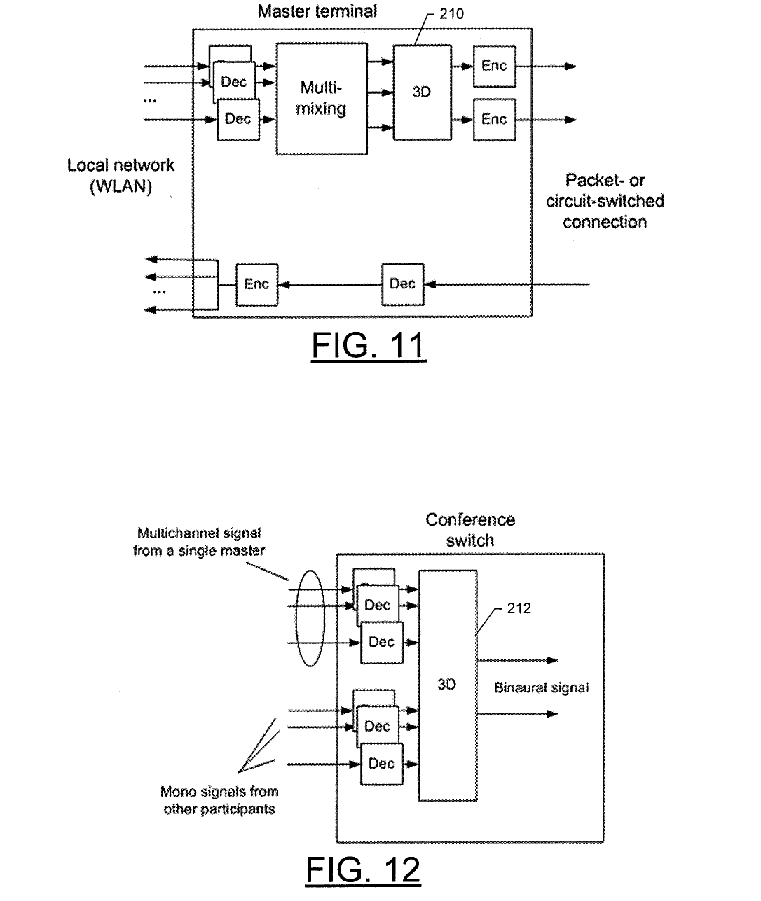

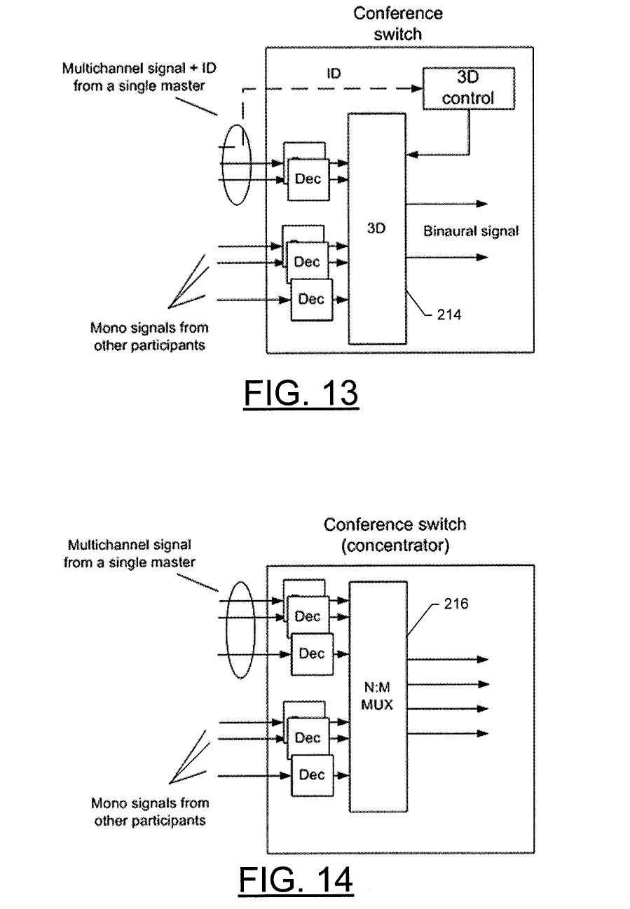

Employing multichannel uplink in a distributed teleconferencing system enables a receiving participant to spatialize the speech signals received from the multichannel distributed teleconferencing system. Positional 3D processing (spatialization) may be performed at various locations, and by various conferencing devices in the conferencing network. For example, 3D processing may be performed in the master device, in a centralized conference switch, and in a receiving device. For example, FIG. 11 is a functional block diagram of a master device of a distributed teleconferencing system of an embodiment of the present invention that spatializes uplink channels. FIG. 12 is a functional block diagram of a conference switch compatible with a multichannel distributed teleconferencing system of an embodiment of the present invention that spatializes received channels from participants. FIG. 13 is a functional block diagram of a conference switch compatible with a multichannel distributed teleconferencing system of an embodiment of the present invention that spatializes received channels from participants and controls spatialization of channels from a multichannel distributed teleconferencing system with active talker ID signaling. And FIG. 14 is a functional block diagram of a conference switch compatible with a multichannel distributed teleconferencing system of an embodiment of the present invention that concentrates multiple input signals, including multichannel signals from a master device.

The embodiment of FIG. 11 represents the first case where 3D processing is performed in the master device. The master device includes a 3D processor, or 3D processing software module, 210 that processes the multimixed signals and sends the 3D signals, such as a binaural signal on the two channels, to the conference network over the two uplink channels. To implement an embodiment where the master device performs 3D processing on the uplink signals, the receiving device also will need to know to interpret the uplink signals from the multichannel distributed teleconferencing system as 3D signals, particularly if the two uplink channels represent a binaural signal rather than two discrete speech signals on the separate channels. An embodiment where two uplink channels are used to transmit a binaural signal may be particularly advantageous where the conferencing connection is between a single 3D capable receiving terminal and a master device or between two master devices.

The embodiments of FIG. 12 and FIG. 13 represent the second case where 3D processing is performed in a centralized conference switch. The embodiment of FIG. 12 represents a situation where the number of logical channels is the same as the number of talker IDs. In such a situation, it may be considered that each device (or talker) is transmitted over its own logical channel and, by default, each logical channel represents the talker ID for each corresponding device (or talker). As such, the conference switch does not require separate active talker identification signaling from the master device of a common acoustic space network, and the conference switch may perform 3D processing on all of the received logical channels according to the channel (or stream) identifier. The embodiment of FIG. 13 represents a situation where the master device of a common acoustic space network performs active talker identification signaling and provides the conference switch with an ID signal to indicate the talker ID (for the device or talker) of each channel. ID information received from the master device for the multichannel distributed teleconferencing system of the common acoustic space network is used by the conference switch to control the spatial positioning of the channels of the multichannel signal. In both situations, the conference switch includes a 3D processor, or 3D processing software module 212, 214 that performs the 3D processing operations. In both situations, the conference switch also needs to know that the signals are coming from the same master device of a multichannel distributed teleconferencing system. This permits the conference switch to exclude the uplink signals from the multichannel distributed teleconferencing system from the signals, sent by the conference switch to the master device of the multichannel distributed teleconferencing system, that represent the speech signals of the other participants of the conference call that are not part of the common acoustic space network of the multichannel distributed teleconferencing system. That is, the conference switch can separate signals for terminals in a common acoustic space network from those that are not part of the common acoustic space network, so avoid re-transmitting signals from terminals in the common acoustic space network back to the common acoustic space network, and thereby back to those same terminals.

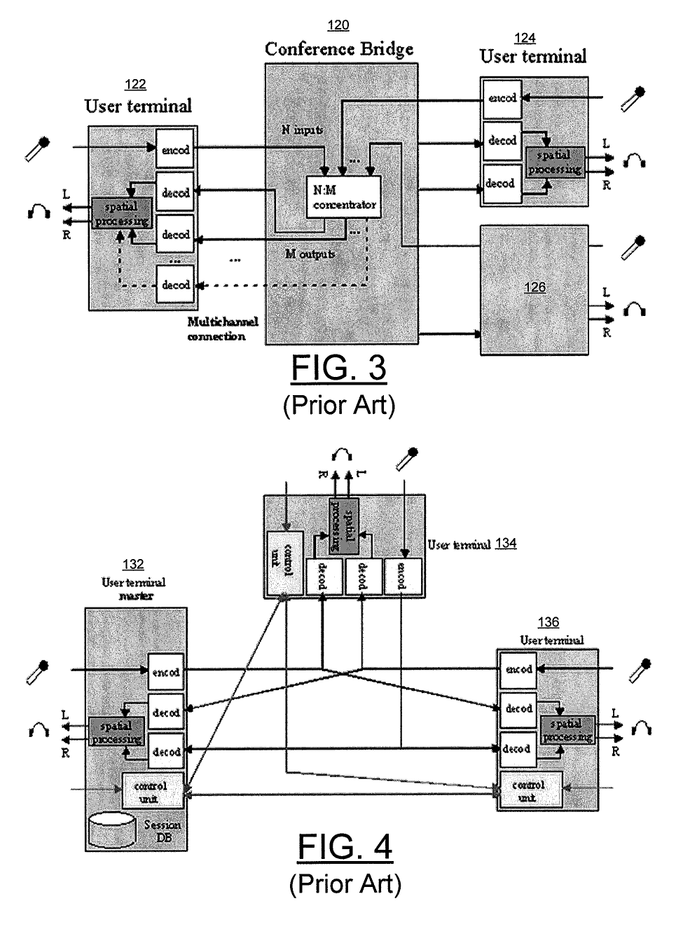

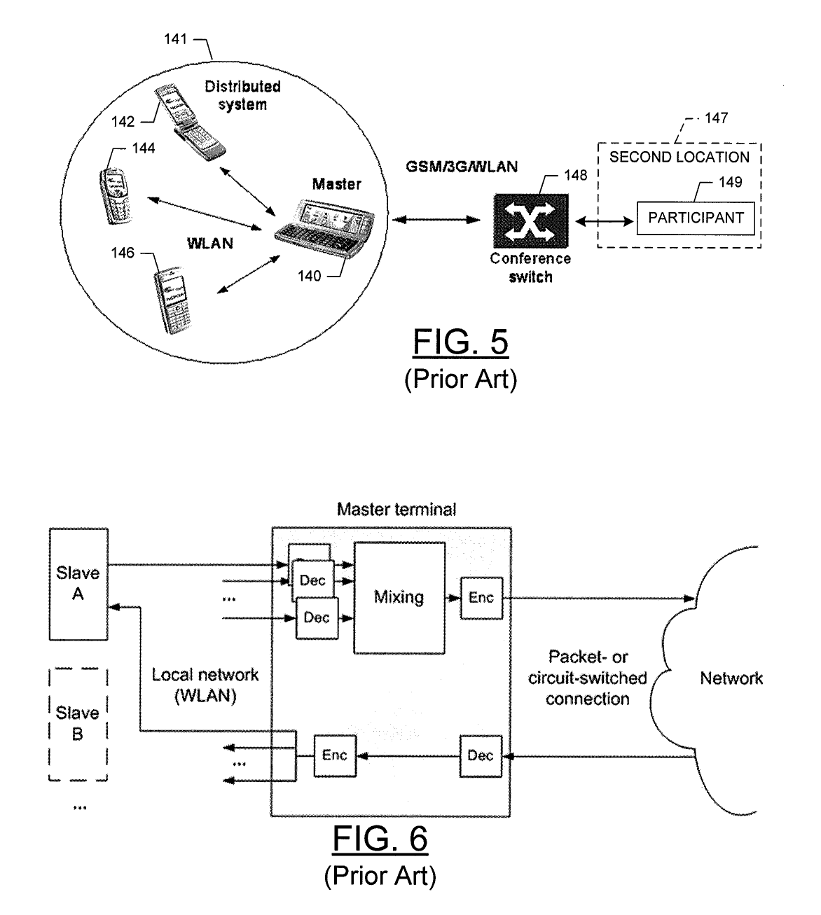

The embodiment of FIG. 14 represents a conference switch for the third case where 3D processing is performed in the receiving terminal. A receiving terminal, such as represented by user terminals 122, 124 of FIG. 3, which may be a master device in a distributed teleconferencing system, includes a 3D processor, or 3D processing software module, that processes the multiplexed signals received from a conference switch, as illustrated in FIG. 14. The conference switch in FIG. 14 includes a multiplexer, or multiplexer in software module, 216, and acts as a concentrator that collects all of the uplink signals from the participants in the conference call and, for example, sends up to a maximum of all of the received uplink signals to the other participants. Less than all of the received uplink signals may be sent to the other participants, such as when the conference switch only sends signals for actively talking participants to the other participants. As noted above, 3D processing of received signals in the downlink direction may be processed at the receiving terminals.

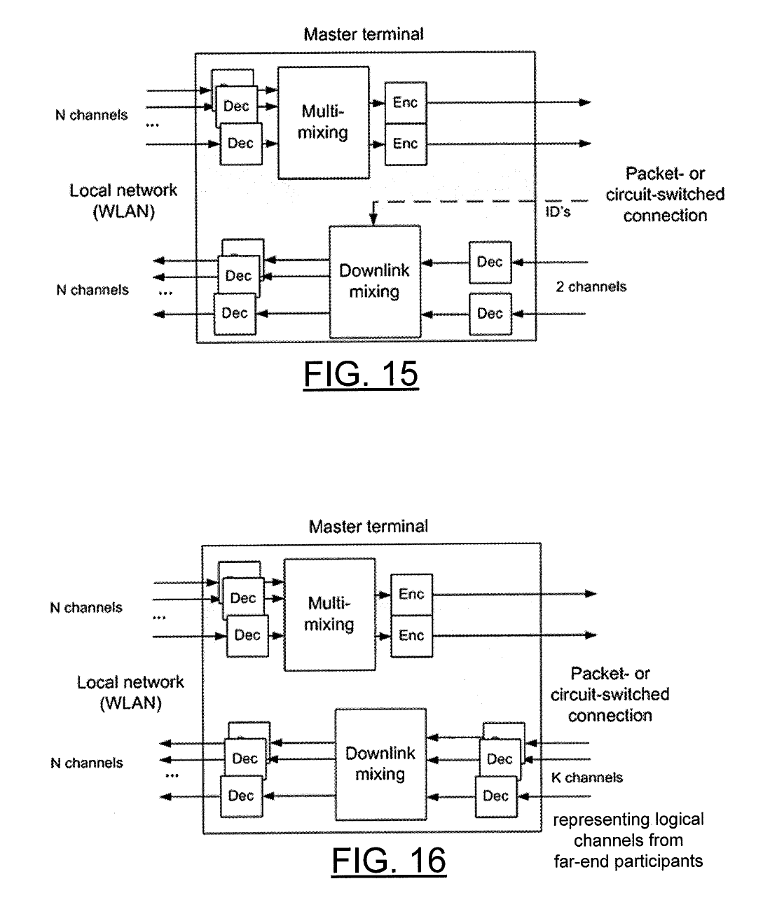

As previously noted, a master device of an embodiment of the present invention may also perform downlink processing for signals received from a conference switch or other participant outside of the common acoustic space network, for example, to regenerate the 3D properties of the received sound or to benefit the functionality of a stereo IHF slave terminal in a proximity network. In such an embodiment, the master device performs downlink processing before retransmitting the received signals to the slave terminals in the common acoustic space network. As in the uplink direction, a master device of an embodiment of the present invention may be capable of and configured for effectuating a multichannel conferencing connection in the downlink direction. That is, a master device, or other conferencing device such as a conference switch or user terminal, can also receive multichannel signals. Downlink multichannel signals may be received directly from another master device capable of and configured for effectuating a multichannel conferencing connection in the uplink direction, from a conference switch that supports multichannel transmission, such as a concentrator conferencing switch of FIG. 3 or FIG. 14, or from a plurality of user terminals. Similar to transmissions in the uplink direction, active talker identification signaling may be implemented by various embodiments of the present invention. For example, FIG. 15 is a functional block diagram of a master device of a distributed teleconferencing system of an embodiment of the present invention with a two-channel downlink connection. In the embodiment of FIG. 15, the master device receives an active talker identification signal to identify actively talking participants (devices or talkers) of signals received over the two downlink channels. Similarly, for example, FIG. 16 is a functional block diagram of a master device of a distributed teleconferencing system of an embodiment of the present invention with a multichannel downlink connection representing logical channels from far-end participants. Unlike the master device of the embodiment of FIG. 15, the master device in the embodiment of FIG. 16 does not require active talker ID signaling because the channel (or stream) identifier itself may indicate the source of the downlink signal. In the embodiment of FIG. 17, the conference switch receives an active talker identification signal from the master device of the common acoustic space network of acoustic space C and transmits an active talker identification signal at least as shown to the master device of the common acoustic space network of acoustic space C. Note that, as described further below, the block diagram of FIG. 17 has been simplified to only shown with mixing operations being performed for downlink signals to the master device of the common acoustic space network of acoustic space C, although, in practice, comparable mixing operations would also be performed for all receiving devices.

In various embodiments of the present invention. when there is only one active talking participant, all downlink signals may be identical, as in the prior art case of a monophonic distributed teleconferencing system, and no downlink mixing is necessary. In such a case or otherwise where the same signal is transmitted from a master device to all the slave terminals in a common acoustic space network, a broadcast signal may be transmitted by the master device. However, when there are simultaneous actively talking participants, the master device may use downlink mixing to generate enhanced downlink signals for reproduction of the speech from participants not in the common acoustic space network by the slave terminals, and possibly also by the master device. For example, because multichannel downlink signals may be reproduced by the loudspeakers of slave terminals, simultaneous actively talking participants may be mixed in such a way that listeners in the common acoustic space may perceive that the simultaneous actively talking participants are localized in different places. Such 3D processing (spatialization and other 3D processing performed during downlink mixing) may improve speech intelligibility for listening participants in the common acoustic space, particularly when spatial separation is perceived between simultaneous actively talking sources (participants). In a further embodiment of the present invention, a master device (or conference bridge) may have a multichannel connection to single participant in common acoustic space network with at least one other terminal, such as in FIGS. 15 and 16. In this regard, a master device (or conference server) may communication with a terminal, of a participant in common acoustic space network with at least one other terminal, by a monophonic signal, a multichannel signal, or a binaural signal. For example, a terminal may receive a multichannel signal or binaural signal to reproduce a 3D representation of the received signal if the terminal is equipped with stereo integrated hands free or stereo headphones.

An alternate embodiment of the present invention may combine the functionality of a master device and a conference switch into a single conferencing device network entity, such as where each of the slave terminals of a common acoustic space network has a connection to a combined master device/conference switch network entity. To differentiate a conference connection of a slave terminal in the common acoustic space network from a participant not in the common acoustic space network but connected to the combined master device/conference switch network entity by a conferencing network connection, such an embodiment of the present invention may employ common acoustic space network mode indication signaling between a slave terminal in the common acoustic space network and the combined master device/conference switch network entity. Such common acoustic space network mode indication signaling may indicate to the combined master device/conference switch network entity that the slave terminal is in the common acoustic space network with other slave terminals. Accordingly the combined master device/conference switch network entity may then function in the manner of a traditional master device for that slave terminal and other slave terminals in the common acoustic space network, such as to exclude signals of the slave terminals in the common acoustic space network that are already in the same physical location from downlink signals, thereby providing downlink signals to slave terminals in the common acoustic space network only representing speech from participants not in the common acoustic space network. Similarly, an embodiment of the present invention may include several common acoustic space networks, such as a plurality of proximity networks, supported by a single conference bridge or combined master device/conference switch network entity, such as described below in relation to FIG. 17.

FIG. 17 is a functional block diagram of a conference switch of an embodiment of the present invention that is compatible with various types of teleconferencing systems. The conference switch receives uplink signals from several acoustic spaces, A, B, C, and D, where there are multiple terminals in at least one of the acoustic spaces. Multiple terminals are located in three of the common acoustic spaces, A, B, and C, and any of these multiple terminals may be connected to the conference bridge by a common space acoustic network for the respective common acoustic space. A single terminal is located in acoustic space D. As previously described, a conference switch may be capable of performing either, or both, uplink and downlink mixing. For example, the conference switch in FIG. 17 performs uplink mixing for signals received from the terminals in common acoustic space A and performs uplink multimixing for the signals received from the terminals in common acoustic space B. By comparison, a master terminal in common acoustic space C provides a common acoustic space network for the terminals in common acoustic space C and performs uplink mixing of the signals from these terminals prior to transmitting a multichannel signal with talker IDs to the conference switch.

Although the conference switch would provide downlink signals to all of the conferencing devices providing uplink signals to the conference switch, downlink signals are only depicted in FIG. 17 for the conferencing device of the common acoustic space network of acoustic space C. Further, the downlink signals that are depicted represent a multichannel signal to the master device of the common acoustic space network of acoustic space C. The conference switch performs downlink mixing and transmits two signals representing active talkers (terminals and/or participants) from the terminals in common acoustic space A, from the terminals in common acoustic space B, and the terminal of acoustic space D. Active talker IDs are provided by the conference switch in the downlink direction to identify the terminals represented by the two (or more) downlink signals. The downlink mixing performed by the conference switch is performed separately for each of the participating terminals, for example, as described above to remove the uplink signal for a terminal from the downlink signal for the same terminal.

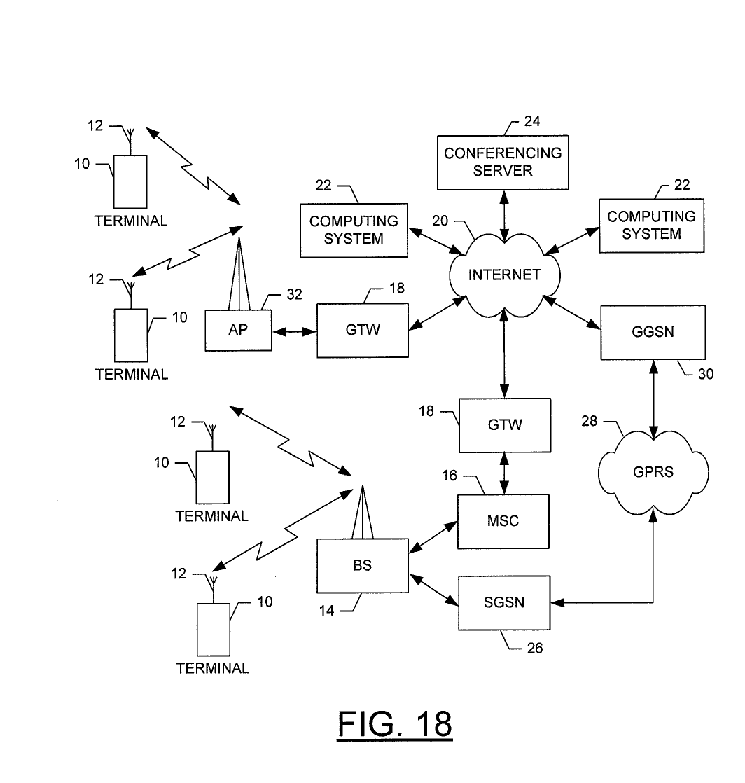

Referring to FIG. 18, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, one or more terminals 10 may each include an antenna 12 for transmitting signals to and for receiving signals from a base site or base station (BS) 14. The base station is a part of one or more cellular or mobile networks each of which includes elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with a computing system 22 (two shown in FIG. 18), conferencing server 24 (one shown in FIG. 18) or the like, as described below.

The BS 14 can also be coupled to a signaling GPRS (General Packet Radio Service) support node (SGSN) 26. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 28. The packet-switched core network is then coupled to another GTW, such as a GTW GPRS support node (GGSN) 30, and the GGSN is coupled to the Internet. In addition to the GGSN, the packet-switched core network can also be coupled to a GTW 18. Also, the GGSN can be coupled to a messaging center. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 26 to the GPRS core network 28 and the GGSN 30, devices such as a computing system 22 and/or conferencing server 24 can be coupled to the terminal 10 via the Internet 20, SGSN and GGSN. In this regard, devices such as a computing system and/or conferencing server can communicate with the terminal across the SGSN, GPRS and GGSN. By directly or indirectly connecting the terminals and the other devices (e.g., computing system, conferencing server, etc.) to the Internet, the terminals can communicate with the other devices and with one another, such as according to the Hypertext Transfer Protocol (HTTP), to thereby carry out various functions of the terminal.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 32. The APs can comprise access points configured to communicate with the terminal in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs may be coupled to the Internet 20. Like with the MSC 16, the APs can be directly coupled to the Internet. In one embodiment, however, the APs are indirectly coupled to the Internet via a GTW 18. As will be appreciated, by directly or indirectly connecting the terminals and the computing system 22, conferencing server 24, and/or any of a number of other devices, to the Internet, the terminals can communicate with one another, the computing system, etc., to thereby carry out various functions of the terminal, such as to transmit data, content or the like to, and/or receive content, data or the like from, the computing system. As used herein, the terms “data,” “content,” “information” and similar terms may be used interchangeably to refer to data configured for being transmitted, received and/or stored in accordance with embodiments of the present invention. Thus, use of any such terms should not be taken to limit the spirit and scope of the present invention.

Although not shown in FIG. 18, in addition to or in lieu of coupling the terminal 10 to computing systems 22 across the Internet 20, the terminal and computing system can be coupled to one another and communicate in accordance with, for example, RF, BT, IrDA or any of a number of different wireline or wireless communication techniques, including LAN, WLAN, WiMAX and/or UWB techniques. One or more of the computing systems can additionally, or alternatively, include a removable memory configured for storing content, which can thereafter be transferred to the terminal. Further, the terminal 10 can be coupled to one or more electronic devices, such as printers, digital projectors and/or other multimedia capturing, producing and/or storing devices (e.g., other terminals). Like with the computing systems 22, the terminal can be configured to communicate with the portable electronic devices in accordance with techniques such as, for example, RF, BT, IrDA or any of a number of different wireline or wireless communication techniques, including USB, LAN, WLAN, WiMAX and/or UWB techniques.

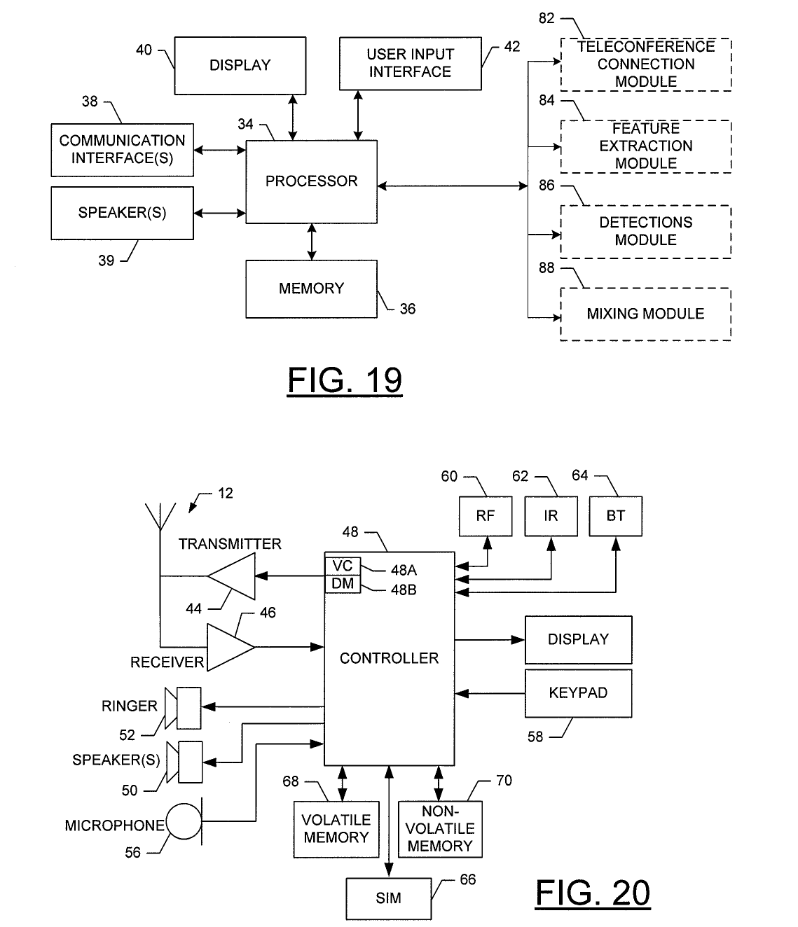

Referring now to FIG. 19, a block diagram of an entity capable of operating as a terminal 10, computing system 22 and/or conferencing server 24 is shown in accordance with one embodiment of the present invention. Although shown as separate entities, in some embodiments, one or more entities may support one or more of a terminal, conferencing server and/or computing system, logically separated but co-located within the entit(ies). For example, a single entity may support a logically separate, but co-located, computing system and conferencing server. Also, for example, a single entity may support a logically separate, but co-located terminal and computing system. Further, for example, a single entity may support a logically separate, but co-located terminal and conferencing server.

The entity capable of operating as a terminal 10, computing system 22 and/or conferencing server 24 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 19, the entity can include a processor, controller, or like processing element 34 connected to a memory 36. The memory can comprise volatile and/or non-volatile memory, and typically stores content, data or the like. For example, the memory typically stores content transmitted from, and/or received by, the entity. Also for example, the memory typically stores computer program code, such as for operating systems and client applications, for the processor to perform steps associated with operation of the entity in accordance with embodiments of the present invention. Memory 36 may be, for example, read only memory (ROM), random access memory (RAM), a flash drive, a hard drive, and/or other fixed data memory or storage device.

As described herein, the client application(s) may each comprise software operated by the respective entities. It should be understood, however, that any one or more of the client applications described herein can alternatively comprise firmware or hardware, without departing from the spirit and scope of the present invention. Generally, then, the terminal 10, computing system 22 and/or conferencing server 24 can include one or more logic elements for performing various functions of one or more client application(s). As will be appreciated, the logic elements can be embodied in any of a number of different manners. In this regard, the logic elements performing the functions of one or more client applications can be embodied in an integrated circuit assembly including one or more integrated circuits integral or otherwise in communication with a respective network entity (i.e., terminal, computing system, conferencing server, etc.) or more particularly, for example, a processor 34 of the respective network entity. The design of integrated circuits is by and large a highly automated process. In this regard, complex and powerful software tools are available for converting a logic level design into a semiconductor circuit design ready to be etched and formed on a semiconductor substrate. These software tools, such as those provided by Avant! Corporation of Fremont, Calif. and Cadence Design, of San Jose, Calif., automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 36, the processor 34 can also be connected to at least one interface or other means for displaying, transmitting and/or receiving data, content or the like. In this regard, the interface(s) can include at least one communication interface 38 or other means for transmitting and/or receiving data, content or the like. As explained below, for example, the communication interface(s) can include a first communication interface for connecting to a first network, and a second communication interface for connecting to a second network. When an entity provides wireless communication to operate in a wireless network, such as a Bluetooth network, a wireless network, or other mobile network, the processor 34 may operate with a wireless communication subsystem of the interface 38. In addition to the communication interface(s), the interface(s) can also include at least one user interface that can include one or more earphones and/or speakers 39, a display 40, and/or a user input interface 42. The user input interface, in turn, can comprise any of a number of devices allowing the entity to receive data from a user, such as a microphone, a keypad, a touch display, a joystick or other input device. One or more processors, memory, storage devices, and other computer elements may be used in common by a computer system and subsystems, as part of the same platform, or processors may be distributed between a computer system and subsystems, as parts of multiple platforms.

If the entity is, for example, a master device or other teleconference capable communication device, the entity may also include a teleconference connection module 82, a feature extraction module 84, a detections module 86, and a mixer or mixing module 88 connected to the processor 34. These modules may be software and/or software-hardware components. For example, a teleconference connection module 82 may include software and/or software-hardware components capable of establishing multichannel conferencing connections and managing the resulting communications between a master device and a conference switch. A feature extraction module 84 may include software capable of extracting or otherwise determining a set of descriptive features, or feature vectors, from respective signals. A detection module 86 may include software capable of performing such audio detection functions as active talker identity detection, double talk detection (DTD), simultaneous talk detection (STD), and voice activity detection (VAD). A mixer or mixing module 88 may include software and/or software-hardware components capable of processing respective signals, such as to combine multiple signals and to affect mixing algorithms upon multiple signals for a multichannel connection.

Reference is now made to FIG. 20, which illustrates one type of terminal 10 that would benefit from embodiments of the present invention. It should be understood, however, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers, mobile telephones, mobile stations, personal gaming devices, personal computers, game consoles, and other types of electronic systems, can readily employ the present invention.

The terminal 10 includes various means for performing one or more functions in accordance with exemplary embodiments of the present invention, including those more particularly shown and described herein. It should be understood, however, that the terminal may include alternative means for performing one or more like functions, without departing from the spirit and scope of the present invention. More particularly, for example, as shown in FIG. 20, in addition to an antenna 12, the terminal 10 includes a transmitter 44, a receiver 46, and a controller 48 that provides signals to the transmitter and receives signals from the receiver. These signals include signaling information in accordance with the air interface standard of the applicable cellular system, and also user speech and/or user generated data. In this regard, the terminal can be configured for operating with one or more air interface standards, communication protocols, modulation types, and access types. More particularly, the terminal can be configured for operating in accordance with any of a number of first generation (1G), second generation (2G), 2.5G and/or third-generation (3G) communication protocols or the like. For example, the terminal may be configured for operating in accordance with 2G wireless communication protocols IS-136 (TDMA), GSM, and IS-95 (CDMA). Also, for example, the terminal may be configured for operating in accordance with 2.5G wireless communication protocols GPRS, Enhanced Data GSM Environment (EDGE), or the like. Further, for example, the terminal may be configured for operating in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 48 includes the circuitry required for implementing the audio and logic functions of the terminal 10. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC) 48A, and may include an internal data modem (DM) 48B. Further, the controller may include the functionality to operate one or more software programs, which may be stored in memory. For example, the controller may be configured for operating a connectivity program, such as a conventional Web browser. The connectivity program may then allow the terminal to transmit and receive Web content, such as according to HTTP and/or the Wireless Application Protocol (WAP), for example.

The terminal 10 also comprises a user interface including one or more output devices, such as earphones and/or speakers 50, a ringer 52, a display 54, and a user input interface, all of which are coupled to the controller 48. The user input interface, which allows the terminal to receive data, can comprise any of a number of devices allowing the terminal to receive data, such as a microphone 56, a keypad 58, a touch display, and/or other input device. In embodiments including a keypad, the keypad includes the conventional numeric (0-9) and related keys (#, *), and other keys used for operating the terminal. Alternatively, or in addition, the keypad may include a QUERTY keypad arrangement. The terminal can also include a battery, such as a vibrating battery pack, for powering the various circuits that are required to operate the terminal, as well as optionally providing mechanical vibration as a detectable output.

The terminal 10 can also include one or more means for sharing and/or obtaining data. For example, the terminal can include a short-range radio frequency (RF) transceiver or interrogator 60 so that data can be shared with and/or obtained from electronic devices in accordance with RF techniques. The terminal can additionally, or alternatively, include other short-range transceivers, such as, for example an infrared (IR) transceiver 62, and/or a Bluetooth (BT) transceiver 64 operating using Bluetooth brand wireless technology developed by the Bluetooth Special Interest Group. The terminal can therefore additionally or alternatively be configured for transmitting data to and/or receiving data from electronic devices in accordance with such techniques. Although not shown, the terminal can additionally or alternatively be configured for transmitting and/or receiving data from electronic devices according to a number of different wireless networking techniques, including WLAN, WiMAX, UWB techniques or the like.

The terminal 10 can further include memory, such as a subscriber identity module (SIM) 66, a removable user identity module (R-UIM) or the like, which typically stores information elements related to a mobile subscriber. In addition to the SIM, the terminal can include other removable and/or fixed memory. In this regard, the terminal can include volatile memory 68, such as volatile Random Access Memory (RAM) including a cache area for the temporary storage of data. The terminal can also include other non-volatile memory 70, which can be embedded and/or may be removable. The non-volatile memory can additionally or alternatively comprise an EEPROM, flash memory, or the like, such as available from the SanDisk Corporation of Sunnyvale, Calif., or Lexar Media Inc., of Fremont, Calif. The memories can store any of a number of pieces of information, and data, used by the terminal to implement the functions of the terminal. For example, the memories can store an identifier, such as an international mobile equipment identification (IMEI) code, international mobile subscriber identification (IMSI) code, mobile station integrated services digital network (MSISDN) code (mobile telephone number), Session Initiation Protocol (SIP) address or the like, capable of uniquely identifying the mobile station, such as to the MSC 16. In addition, the memories can store one or more client applications configured for operating on the terminal.

In accordance with exemplary embodiments of the present invention, a conference session can be established between a plurality of participants via a plurality of devices (e.g., terminal 10, computing system 22, etc.) in a distributed or centralized arrangement via a conferencing server 24. The participants can be located at a plurality of remote locations that each includes at least one participant. For at least one of the locations including a plurality of participants, those participants can form a network in the common acoustic space. During the conference session, then, the participants' devices can generate signals representative of audio or speech activity adjacent to and thus picked up by the respective devices. The signals can then be mixed into an output signal for communicating to other participants of the conference session.

According to one aspect of the present invention, the functions performed by one or more of the entities of the system, such as a terminal 10, computing system 22, or conferencing server 24 may be performed by various means, such as hardware and/or firmware, including those described above, alone and/or under control of a computer program product (e.g., a mixer 88). The computer program product for performing one or more functions of embodiments of the present invention includes a computer-readable storage medium, such as the non-volatile storage medium, and software including computer-readable program code portions, such as a series of computer instructions, embodied in the computer-readable storage medium. Similarly, embodiments of the present invention may be incorporated into hardware and software systems and subsystems, combinations of hardware systems and subsystems and software systems and subsystems, and incorporated into network devices and systems and mobile stations thereof. In each of these network devices and systems and mobile stations, as well as other devices and systems capable of using a system or performing a method of the present invention as described above, the network devices and systems and mobile stations generally may include a computer system including one or more processors that are capable of operating under software control to provide the techniques described above.

In this regard, each block or step of a functional block diagram or flowchart, and combinations of blocks in a functional block diagram or flowchart, can be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the functional block diagrams' and flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the functional block diagrams' and flowchart's block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the functional block diagrams' and flowchart's block(s) or step(s).

Accordingly, blocks or steps of the functional block diagrams and flowchart support combinations of means for performing the specified functions, combinations of steps for performing the specified functions and program instruction means for performing the specified functions. It will also be understood that one or more blocks or steps of the functional block diagrams and flowchart, and combinations of blocks or steps in the functional block diagrams and flowchart, can be implemented by special purpose hardware-based computer systems which perform the specified functions or steps, or combinations of special purpose hardware and computer instructions.

Provided herein are improved teleconferencing architectures, systems, methods, and computer program products for distributed teleconferencing using one or more master devices and/or a centralized conferencing switch. Multichannels enhance functionality of a master device in distributed teleconferencing and allow for compatibility with 3D capable teleconferencing, thereby enabling 3D capable teleconferencing devices and terminals that are part of a multichannel distributed teleconferencing system to participate in the same conference session with 3D audio features enabled. Multichannel distributed teleconferencing involves multichannel uplink, monophonic uplink, or a fixed number of uplink channels and involves multichannel downlink, monophonic downlink, or a fixed number of downlink channels. A multichannel distributed teleconferencing system may perform active talker detection of near-end participants and communicate an ID signal on an uplink channel identifying the active near-end participants. A multichannel distributed teleconferencing system may also receive an ID signal on a downlink channel identifying the active far-end participants. A multichannel distributed teleconferencing system may perform various uplink and downlink processing. Uplink processing may involve multimixing and spatialization. Multimixing may be used to separate speech signals of near-end participants. Spatialization, also used in downlink processing, introduces spatial separation of active participants.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A conferencing device for effectuating a distributed conference session employing a distributed architecture between a plurality of participants, at least a first participant and a second participant being at a first location, wherein the first location is a common acoustic space, and at least a third participant being at a remote location, the conferencing device comprising:
a processing element configured for receiving a first audio signal from the first participant and a second audio signal from the second participant and providing the first and second audio signals to the third participant, wherein the processing element receives the first and second audio signals from a common acoustic space network connecting the conferencing device with the first and second participants, and wherein the processing element is further configured for providing the first and second audio signals to the third participant over a multichannel conferencing connection with the third participant, the processing element further configured for receiving a third audio signal from the third participant and providing the third audio signal to the first and second participants.

2. The conferencing device of claim 1, wherein the processing element is further configured for receiving a fourth audio signal from a fourth participant, wherein the third and fourth participants are in a common acoustic space and participate in the conference session through a common acoustic network effectuated by another conferencing device, and wherein the processing element receives the third and fourth audio signals over a multichannel conferencing connection from the another conferencing device effectuating the common acoustic space network for the third and fourth participants.

3. The conferencing device of claim 2, wherein the processing element receives the third and forth audio signals over a fixed two-channel conferencing connection.

4. The conferencing device of claim 3, wherein the processing element further receives an ID signal representing the identification of the participants representing the active signals received over the fixed two-channel conferencing connection.

5. The conferencing device of claim 4, wherein the processing element is further configured for performing downlink processing of the third and forth audio signals received over the fixed two-channel conferencing connection, and wherein the downlink processing comprises performing spatialization of the third and forth audio signals received over the fixed two-channel conferencing connection.

6. The conferencing device of claim 2, wherein the processing element is further configured for receiving a fifth audio signal from a fifth participant, wherein the fifth participant does not participate in either the common acoustic space network of the first and second participants or the another common acoustic space network of the third and fourth participants.

7. The conferencing device of claim 1, wherein the processing element receives the third audio signal over a monophonic conferencing connection.

8. The conferencing device of claim 1, wherein the processing element provides the first and second audio signals to the third participant over a fixed two-channel conferencing connection.

9. The conferencing device of claim 8, wherein a forth participant is also in the common acoustic space network of the first and second participants, wherein the processing element is further configured for multiplexing at least the first and second audio signals and a fourth audio signal received from the common acoustic space network for the fourth participant, and further configured for identifying no more than two of the at least three audio signals received from the common acoustic space network as active signals to provide to the third participant over the fixed two-channel conferencing connection.

10. The conferencing device of claim 9, wherein the processing element is further configured for identifying the participants representing the active signals, generating an ID signal representing the identification of the participants representing the active signals, and providing the ID signal to at least the third participant.

11. The conferencing device of claim 1, wherein the processing element receives the third audio signal over a multichannel conferencing connection where the signal is a spatialized signal.

12. The conferencing device of claim 1, wherein the processing element is further configured for identifying the participants of the common acoustic space, generating an ID signal representing the identification of the participants of the common acoustic space network, and providing the ID signal to the third participant.

13. The conferencing device of claim 1, wherein the processing element is further configured for performing uplink processing, and wherein the uplink processing comprises performing multimixing of received signals of participants within the common acoustic space into at least a two-channel signal for output to one or more participants outside the common acoustic space.

14. The conferencing device of claim 13, wherein the multimixing comprises performing feature extraction, channel ranking, and parallel mixing operations of received audio signals from participants in the common acoustic space.

15. The conferencing device of claim 13, wherein the multimixing comprises performing automatic volume control (AVC).

16. The conferencing device of claim 13, wherein the multimixing comprises performing simultaneous talk detection (STD) on received audio signals from participants in the common acoustic space, voice activity detection (VAD) on received audio signals from participants in the common acoustic space and on received audio signals from participants at locations outside of the common acoustic space, and double talk detection (DTD) on received audio signals from participants in the common acoustic space and received audio signals from participants at locations outside of the common acoustic space.

17. The conferencing device of claim 13, wherein the multimixing further comprises performing spatialization of received audio signals from participants in the common acoustic space.

18. The conferencing device of claim 1, wherein the common acoustic space network is a proximity network.

19. The conferencing device of claim 1, wherein the common acoustic space network is a circuit-switched connection network.

20. A method for effectuating a conference session between participants at more than one location, at least a first participant and a second participant at a first location and at least a third participant being at a remote location, comprising:
establishing a multichannel conferencing connection between a common acoustic space network at the first location and another conference device of the conference session, wherein the first and second participants are connected to the another conference device of the conference session by the common acoustic space network at the first location;
receiving a first audio signal from the first participant and a second audio signal from the second participant, wherein the first and second audio signals are received from the common acoustic space;
providing the first and second audio signals to the third participant;
receiving a third audio signal from the third participant; and
providing the third audio signal to the first and second participants.

21. The method of claim 20, further comprising:
establishing a multichannel conferencing connection between a common acoustic space network at the remote location and the another conference device of the conference session or the common acoustic space network at the first location, wherein the third participant and a fourth participant participate in the conference session through the common acoustic space network at the remote location; and
receiving a forth audio signal from a forth participant over the multichannel conferencing connection with the third and forth participants, and wherein the third audio signal from the third participant is also received over the multichannel conferencing connection with the third and forth participants.

22. The method of claim 21, further comprising performing processing of the third and forth audio signals received over the multichannel conferencing connection, wherein the downlink processing comprises performing spatialization of the third and forth audio signals.

23. The method of claim 20, further comprising:
multiplexing at least the first and second audio signals and a third audio signal received from the common acoustic space network;
identifying less than all of the at least three audio signals received from the common acoustic space network as active signals to provide to the third participant;
providing the audio signals of the less than all of the at least three audio signals received from the common acoustic space network identified as active signals to the third participant.

24. The method of claim 23, further comprising:
identifying the participants representing the active signals;
generating an ID signal representing the identification of the participants representing the active signals; and
providing the ID signal to the third participant.

25. The method of claim 20, further comprising performing uplink processing, wherein the uplink processing comprises performing multimixing of received signals of participants within the common acoustic space network into at least two mixed signals for output to one or more participants outside the common acoustic space network.

26. The method of claim 25, wherein the multimixing comprises performing feature extraction, channel ranking, and parallel mixing operations of received audio signals from participants in the common acoustic space network.

27. The method of claim 25, wherein the multimixing comprises performing simultaneous talk detection (STD) on received audio signals from participants in the common acoustic space network, voice activity detection (VAD) on received audio signals from participants in the common acoustic space and on received audio signals from participants at locations outside of the common acoustic space, double talk detection (DTD) on received audio signals from participants in the common acoustic space and received audio signals from participants at locations outside of the common acoustic space.

28. The method of claim 25, wherein the multimixing further comprises performing spatialization of received audio signals from participants in the common acoustic space.

29. The method of claim 20, further comprising performing downlink processing of the received audio signals, wherein the downlink processing comprises performing spatialization of the third and forth audio signals received over the multichannel conferencing connection.

30. A computer program product comprising a computer-useable medium having control logic stored therein for effectuating a conference session between participants at more than one location, at least a first participant and a second participant at a first location and at least a third participant being at a remote location, the control logic comprising:
a first code configured for establishing a multichannel conferencing connection between a common acoustic space network at the first location and another conference device of the conference session, wherein the first and second participants are connected to the another conference device of the conference session by the common acoustic space network at the first location;
a second code configured for receiving a first audio signal from the first participant and a second audio signal from the second participant, wherein the first and second audio signals are received from the common acoustic space network;
a third code configured for providing the first and second audio signals to the third participant;
a forth code configured for receiving a third audio signal from the third participant; and
a fifth code configured for providing the third audio signal to the first and second participants.

31. The computer program product of claim 30, further comprising:
a sixth code configured for establishing a multichannel conferencing connection between a common acoustic space network at the remote location and the another conference device of the conference session or the common acoustic space network at the first location, wherein the third participant and a fourth participant participate in the conference session through the common acoustic space network at the remote location; and
a seventh code configured for receiving a forth audio signal from a forth participant over the multichannel conferencing connection with the third and forth participants, and wherein the third audio signal from the third participant is also received over the multichannel conferencing connection with the third and forth participants.

32. The computer program product of claim 31, further comprising an eighth code configured for performing processing of the third and forth audio signals received over the multichannel conferencing connection, wherein the downlink processing comprises performing spatialization of the third and forth audio signals.

33. The computer program product of claim 30, further comprising:
a sixth code configured for multiplexing at least the first and second audio signals and a third audio signal received from the common acoustic space network;
a seventh code configured for identifying less than all of the at least three audio signals received from the common acoustic space network as active signals to provide to the third participant;
an eighth code configured for providing the audio signals of the less than all of the at least three audio signals received from the common acoustic space network identified as active signals to the third participant.

34. The computer program product of claim 33, further comprising:
a ninth code configured for identifying the participants representing the active signals;
a tenth code configured for generating an ID signal representing the identification of the participants representing the active signals; and
an eleventh code configured for providing the ID signal to the third participant.

35. The computer program product of claim 30, further comprising a sixth code configured for performing uplink processing, wherein the uplink processing comprises performing multimixing of received signals of participants within the common acoustic space into at least two mixed signals for output to one or more participants outside the common acoustic space.

36. The computer program product of claim 35, wherein the multimixing comprises performing feature extraction, channel ranking, and parallel mixing operations of received audio signals from participants in the common acoustic space.

37. The computer program product of claim 35, wherein the multimixing comprises performing simultaneous talk detection (STD) on received audio signals from participants in the common acoustic space, voice activity detection (VAD) on received audio signals from participants in the common acoustic space and on received audio signals from participants at locations outside of the common acoustic space, double talk detection (DTD) on received audio signals from participants in the common acoustic space and received audio signals from participants at locations outside of the common acoustic space.

38. The computer program product of claim 30, further comprising a sixth code configured for performing downlink processing of the received audio signals, wherein the downlink processing comprises performing spatialization of the third and forth audio signals received over the multichannel conferencing connection.

39. A conferencing device for effectuating a distributed conference session employing a distributed architecture between a plurality of participants, the conferencing device comprising:
a processing element configured for transmitting and receiving conferencing signals over a multichannel connection,
wherein the processing element is further configured for transmitting conferencing signals representing a plurality of participants,
wherein the processing element is further configured for receiving conferencing signals representing a plurality of participants, and
wherein the processing element is further configured for establishing the multichannel connection with at least one of the following other conferencing devices: a master device of a common acoustic space network, a conference switch, a plurality of individual terminals.

40. The conferencing device of claim 39, wherein the conferencing device comprises a master device of a common acoustic space network.

41. The conferencing device of claim 40, wherein the other conferencing device is another master device of another common acoustic space network.

42. The conferencing device of claim 40, wherein the conferencing device comprises a mobile station.

43. The conferencing device of claim 39, wherein the conferencing device comprise a conference switch.
